(19) United States
(12) Patent Application Publication
(10) Pub. No.: US 2015/0225820 A1
(43) Pub. Date: Aug. 13, 2015

(54) NICKEL FREE STAINLESS STEEL ALLOY

(71) Applicant: The Swatch Group Research and Development Ltd, Marin (CH)

(72) Inventor: Jean-Francois Dionne, Kerzers (CH)

(73) Assignee: The Swatch Group Research and Development Ltd, Marin (CH)

(21) Appl. No.: 14/425,455

(22) PCT Filed: Oct. 17, 2013
(86) PCT No.: PCT/EP2013/071770

§ 371 Date: Mar. 3, 2015

(30) Foreign Application Priority Data
Nov. 2, 2012 (EP) 12191101.0

(51) Int. Cl. C22C 38/38; G04G 17/02; C22C 38/28; C22C 38/26; C22C 38/24; C22C 30/02; C22C 38/20; C22C 38/04; C22C 38/02; C22C 38/00; C22C 30/00; G04G 17/08; C22C 38/22

(52) U.S. Cl. CPC C22C 38/38; G04G 17/08; G04G 17/02; C22C 38/28; C22C 38/26; C22C 38/24; C22C 38/22; C22C 38/20; C22C 38/04; C22C 38/02; C22C 38/005; C22C 38/004; C22C 38/001; C22C 30/00; C22C 30/02

(57) ABSTRACT

An austenitic face-centered cubic stainless steel alloy contains less than 0.5 mass % of nickel, and includes, by mass:
chromium: 16% to 20%;
an additional metal: 30% to 40% selected from among copper, ruthenium, rhodium, palladium, rhenium, osmium, iridium, platinum and gold:
copper: 0% to 2%;
gold: 0% to 2%;
carbon: 0% to 0.03%;
molybdenum: 0% to 2%;
manganese: 0% to 2%;
silicon: 0% to 1%;
nitrogen: 0% to 0.1%;
tungsten: 0% to 0.5%;
vanadium: 0% to 0.5%;
niobium: 0% to 0.5%;
zirconium: 0% to 0.5%;
titanium: 0% to 0.5%;
iron and inevitable impurities.

### FIELD OF THE INVENTION

The invention concerns a stainless steel alloy with a base formed of iron and chromium.

The invention also concerns a timepiece component made of this type of alloy.

The invention concerns the fields of horology and jewellery, in particular for the following structures: watch cases, watch middle parts, bottom plates, bracelets or wristbands, rings, earrings and others.

### BACKGROUND OF THE INVENTION

Stainless steels are commonly used in the fields of horology and jewellery, in particular for the following structures: watch cases, watch middle parts, bottom plates, bracelets or wristbands and other structures.

Components for external use, intended to be in contact with the user's skin, must comply with certain constraints, in particular because of the allergenic effects of certain metals, notably nickel. Despite the protective qualities and brilliance of nickel when polished, endeavours are increasingly made to place on the market alloys containing little or no nickel.

Nickel is, however, a basic component of most ordinary stainless steels, since it improves mechanical properties and ductility, malleability and resilience. However, nickel has detrimental effects with regard to friction surfaces. Nickel improves the properties of the passive layer and is integrated in the surface oxide layer. In particular, the alloy X2CrNiMo17-12 EN (or 316L AISI) includes between 10.5 and 13% nickel. Nickel is a metal with a continually increasing price, which, in 2012, was close to USD 20,000 per ton, which increases the price of alloys containing nickel.

Nickel free stainless steel alloys are known which are ferritic steels having a body-centred cubic structure. However, these ferritic steels cannot be hardened by heat treatment, but only by cold working. They have a rough structure and this family of alloys is not suitable for polishing.

EP Patent Application No 0964071 A1 in the name of Asulab SA discloses the application of this type of nickel free ferritic stainless steel to an external watch part, said alloy including at least 0.4% by weight of nitrogen and a maximum of 0.5% by weight of nickel, between 10 and 35% by mass of the total of chromium and molybdenum, and between 5 and 20% by mass of manganese.

Other nickel free stainless steel alloys are known which are martensitic steels, which can be hardened by heat treatment, however they are difficult to machine, particularly the maraging steel grades which include hardening precipitates, and cannot be envisaged for horological applications.

EP Patent No 0629714 B1 in the name of Ugine-Savole Imphy discloses a martensitic stainless steel with improved machinability, with a level of nickel which is not zero, but comprised between 2 and 6%, a relatively low chromium level comprised between 11% and 19% and a composition that provides for numerous additives and favours the formation of certain inclusions in the matrix, thereby improving machinability by localised chip embrittlement. However, it is clear that, although low, the level of nickel remains too high for the application.

Austenitic steels, with a face-centred cubic structure, generally have very good shaping properties, which is particularly advantageous for timepiece or jewellery components. They have very high chemical resistance. They are also non-magnetic due to their face-centred cubic structure. They are also the most suitable for welding. However ordinary austenitic stainless steels still include between 3.5 and 32% nickel and more frequently from 8.0 to 15% nickel. Indeed, nickel is a gammagenous element which allows obtention of the austenitic structure and, in particular, sheet steels suitable for shaping deformations. Some documents, like FR Patent No 2534931 in the name of Cabot Corporation, go as far as to assert that nickel must be present to favour an austenitic structure in the alloy.

In theory, the gamma loop of the iron-chromium system peculiar to stainless steels defines an austenitic domain, even with a low or zero level of nickel, but the loop is of very restricted amplitude compared to those of alloys including a higher proportion of nickel. Further, this austenitic domain exists at much higher than the ambient temperatures. The effect of gammagenous alloy elements is twofold since it also expands the chemical composition of the austenitic loop (relative to chromium) and increases the temperature range at which the structure is stable.

Austeno-ferritic steels, also called duplex steels, are slightly magnetic and generally include between 3.5% and 8% nickel.

In short, although it is generally accepted that nickel free stainless steels are mainly ferritic steels, it should be possible to have the advantages of austenitic steels, which are generally classified as nickel steels.

To obtain an austenitic stainless steel, gammagenous elements are generally used, such as nickel, manganese or nitrogen (the latter two are known as super-austenitic steels), which increase the range of stability of the austenite. Theoretically, it would thus be possible to use a super-austenitic steel with manganese or nitrogen instead of nickel.

EP Patent No 1025273 B1 in the name of Sima discloses a nickel free austenitic stainless steel of this type, including 15 to 24% manganese, 15 to 20% chromium, 2.5 to 4% molybdenum, 0.6 to 0.85% nitrogen, 0.1 to 0.5% vanadium, less than 0.5% copper, less than 0.5% cobalt, less than 0.5% total niobium and tantalum, less than 0.06% carbon, other elements each limited to 0.020% by mass, the remainder being formed of iron, and the compositions of certain metals being limited in relation to each other through a system of equations and inequalities, which define their levels of chromium, molybdenum, nitrogen, vanadium, niobium and manganese.

However, although these super-austenitic alloys have high mechanical properties, they are very difficult to shape, in particular machining is difficult, die forging is impossible and consequently they are inconvenient to use.

Austenitic stainless steels are known from the following documents:
EP Patent Application No 1783240 A1 in the name of Daido Steel Co Ltd for use, in particular, in jewellery and having a high nitrogen level;
EP Patent No 1025273 B1 in the name of Métallurgie Avancée Sima—nickel free for biomedical applications;
EP Patent Application No 1626101 A1 in the name of Daido Steel Co Ltd—with a high nitrogen level;
EP Patent Application No 0896072 A1 in the name of Usinor Ugine—with a very low nickel level;
US Patent Application No 2009/060775 A1 in the name of Liu Advanced Int Multitech—with a medium level of nitrogen;
DE Patent Application No 19716795 A1 in the name of Krupp—highly resistant and corrosion resistant;
U.S. patent application No. 3,904,401 A in the name of Mertz Carpenter Technology Co—corrosion resistant.

### SUMMARY OF THE INVENTION

The invention concern a stainless steel alloy with a base formed of iron and chromium, characterized in that it includes less than 0.5% by mass of nickel and is arranged in an austenitic face-centred cubic structure and it consists, in values by mass, of:
chromium: minimum value 16%, maximum value 20%;
at least one additional metal, the value of the total of said at least one additional metal or said additional metals being comprised between: minimum value 30% and maximum value 40%, said at least one additional metal being selected from among a first group comprising copper, ruthenium, rhodium, palladium, rhenium, osmium, iridium, platinum and gold:
the copper value being comprised between: minimum value 0% and maximum value 2%;
the gold value being comprised between: minimum value 0% and maximum value 2%;
carbon: minimum value 0%, maximum value 0.03%;
molybdenum: minimum value 0%, maximum value 2%;
manganese: minimum value 0%, maximum value 2%;
silicon: minimum value 0%, maximum value 1%;
nitrogen: minimum value 0%, maximum value 0.1%;
tungsten: minimum value 0%, maximum value 0.5%;
vanadium: minimum value 0%, maximum value 0.5%;
niobium: minimum value 0%, maximum value 0.5%;
zirconium: minimum value 0%, maximum value 0.5%;
titanium: minimum value 0%, maximum value 0.5%;
iron and inevitable impurities: the complement to 100%.

The invention further concerns a timepiece or jewellery component made of this type of alloy.

### BRIEF DESCRIPTION OF THE DRAWINGS

Other features and advantages of the invention will appear upon reading the following detailed description, with reference to the annexed drawings, in which:

FIG. 1 shows a schematic view of the gamma loop of an iron-chromium system, as a function of the level of nickel in the alloy.

FIG. 2 shows a Schaeffler diagram, with a chromium equivalent on the x-axis and a nickel equivalent on the y-axis. This diagram delimits the ferritic, martensitic and austenitic domains, the latter being limited by the curve for a zero ferrite level.

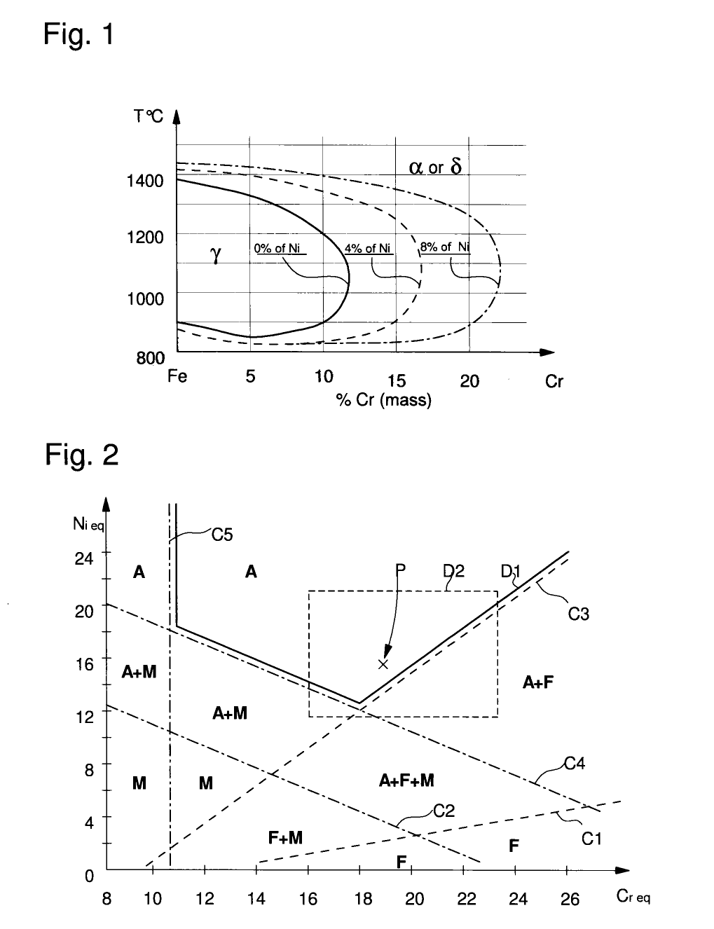

### DETAILED DESCRIPTION OF PREFERRED EMBODIMENTS

The invention proposes to produce nickel free stainless steels, which have similar properties to those of austenitic stainless steels containing nickel.

Hereinafter, a “nickel free alloy” means an alloy including less than 0.5% by mass of nickel.

It is therefore sought to manufacture alloys which, like super-austenitic alloys, include substitutes for nickel, but which harden the steel less than the combination manganese-nitrogen.

These nickel substitutes must be soluble in iron, so as to allow the construction of an austenitic face-centred cubic structure. According to the invention, in addition to a base formed of iron and chromium, the alloy includes at least one additional metal selected from among a first group including copper, ruthenium, rhodium, palladium, rhenium, osmium, irrdium, platinum and gold.

In a preferred composition, the stainless steel alloy according to the invention includes less than 0.5% by mass of nickel, in a base formed of iron and chromium, and is arranged in an austenitic face-centred cubic structure, and consists, in values by mass, of:
chromium: minimum value 16%, maximum value 20%;
at least one additional metal, the value of the total of said at least one additional metal or said additional metals being comprised between: minimum value 30% and maximum value 40%, said at least one additional metal being selected from among a first group comprising copper, ruthenium, rhodium, palladium, rhenium, osmium, iridium, platinum and gold:
the copper value being comprised between: minimum value 0% and maximum value 2%;
the gold value being comprised between: minimum value 0% and maximum value 2%;
carbon: minimum value 0%, maximum value 0.03%;
molybdenum: minimum value 0%, maximum value 2%;
manganese: minimum value 0%, maximum value 2%;
silicon: minimum value 0%, maximum value 1%;
nitrogen: minimum value 0%, maximum value 0.1%;
tungsten: minimum value 0%, maximum value 0.5%;
vanadium: minimum value 0%, maximum value 0.5%;
niobium: minimum value 0%, maximum value 0.5%;
zirconium: minimum value 0%, maximum value 0.5%;
titanium: minimum value 0%, maximum value 0.5%;
iron and inevitable impurities: the complement to 100%.

In a particular application, in addition to a base formed of iron, carbon and chromium, the alloy includes at least one additional metal selected from among a first sub-group of the first group, called platinoids, said platinoid sub-group including ruthenium, rhodium, palladium, rhenium, osmium, iridium and platinum.

Indeed, these metals form part of the platinum group metals (PGM) or platinoids, i.e. they are characterized by common properties which are unusual for metals. These PMG metals are also more soluble in iron than copper and gold.

In another more particular composition, said at least one additional metal is exclusively selected from among this platinoid sub-group.

A variant of the invention consists in incorporating in the alloy not only at least one additional metal of this type but also manganese and nitrogen, in order to adjust the mechanical properties of the alloy. Preferably, in this second variant, the alloy consists, in values by mass, of:
chromium: minimum value 16%, maximum value 20%;
manganese: minimum value 0%, maximum value 2%;
nitrogen: minimum value 0%, maximum value 0.1%;
at least one said additional metal from the first group, the total value of the at least one additional metal or additional metals being comprised between: minimum value 30% and maximum value 40%
the copper value being comprised between: minimum value 0% and maximum value 2%;
the gold value being comprised between: minimum value 0% and maximum value 2%;
   and the total, on the one hand, of the additional metal or the additional metals of the first group or of the platinoid sub-group, and, on the other hand, the manganese and nitrogen, being comprised between the following values: minimum value 30%, maximum value 40%;
molybdenum: minimum value 0%, maximum value 2%;
silicon: minimum value 0%, maximum value 1%;
carbon: minimum value 0%, maximum value 0.03%;
silicon: minimum value 0%, maximum value 1%;
tungsten: minimum value 0%, maximum value 0.5%;
vanadium: minimum value 0%, maximum value 0.5%;
niobium: minimum value 0%, maximum value 0.5%;
zirconium: minimum value 0%, maximum value 0.5%;
titanium: minimum value 0%, maximum value 0.5%;
iron and inevitable impurities: the complement to 100%.

Another variant of the invention consists in incorporating in the alloy, within the limit of 0.5% by mass of the total, at least one carburigen element taken from among a second group including tungsten, vanadium, niobium, zirconium, and titanium to replace an equivalent mass of iron in the alloy. Thus, in the alloy, at least one carburigen element taken from among a second group including tungsten, vanadium, niobium, zirconium, and titanium has a non zero level, within the limit of 0.5% of the total of carburigen elements of this second group.

The incorporation of one or more carburigen elements has the effect of forcing the precipitation of specific carbides which are less deterimental for corrosion resistance than chromium carbides.

FIG. 2 is a Schaeffler diagram, which includes a chromium equivalent on the x-axis, and a nickel equivalent on the y-axis, both in percentage by mass.

The chromium equivalent Créq answers the following definition here:

Créq=Cr+Mo+1.5 Si.

This model is close to the Schaeffler model or the Delong model:

Créq=Cr+Mo+1.5 Si+0.5 Nb,

simplified here for the case of a niobium free alloy.

The important point is to determine the prescribed level of additional metal, as a substitute for nickel. The notion of nickel equivalent qualifies the proportion by mass of the additional metal, or additional metals if there are more than one.

In the particular case of the use of palladium to replace nickel, the nickel equivalent Niéq answers the following definition:

Niéq=Ni+30 (C+N)+0.5 (Co+Mn+Cu)+0.3 Pd.

This model is adapted to the presence of palladium, and is derived from known Schaeffler models (for a manganese based alloy):

Niéq=Ni+30C+0.5 Mn,

and more specifically from Delong (for a manganese and nitrogen based alloy):

Niéq=Ni+30 (C+N)+0.5 Mn.

Generalised to the group of additional metals, the nickel equivalent formula may also be written:

Niéq=Ni+30(C+N)+0.5(Co+Mn+Cu)+0.3(Pd+Ru+Rh+Re+Os+Ir+Pt+Au),

or, preferably in the case where the additional metal is selected from the first group:

Niéq=Ni+30(C+N)+0.5(Co+Mn+Cu)+0.3(Pd+Ru+Rh+Re+Os+Ir+Pt).

This Schaeffler diagram delimits the ferritic, martensitic and austenitic domains, the latter being limited by the zero ferrite level curve.

Stainless steels are, according to current standards, those which contain more than 10.5% chromium.

Curves C1 and C2 delimit the possible presence of austenite A: above C1 and C1 there is austenite A, below there is not.

Curve C3 delimits the possible presence of ferrite F: below C3 there is ferrite F, above there is not.

Curve C4 delimits the possible presence of martensite M: below C4 there is martensite M, above there is not.

To take maximum advantage of the properties of austenite, the composition must be such that it is above both curves C3 and C4, so as to only have austenite A.

To take maximum advantage of the properties peculiar to stainless steels, the minimum level of chromium represented by curve C5 must be observed, and the domain is then that located to the right of curve C5. The hatched domain D1 in FIG. 2 complies with these two conditions and ensures the expected properties. Point P corresponding to the aforecited example is located within this domain D1.

According to an approximation, the curves are straight lines with the equations:

C1: Niéq=−5/6 (Créq−8)+21

C2 Niéq=−13/16 (Créq−8)+13

C3 Niéq=13/9 (Créq−8)−2

C4 Niréq=7/16 (Créq−8)−3

Domain D1 complies with the following three conditions:

Niéq≧13/9(Créq−8)−2

Niéq≧7/16(Créq−8)−3

Créq≧10.5

Naturally, the presence of a small amount of ferrite or martensite with the austenite can be tolerated, and the real domain of application may be slightly broader than domain D1, in particular to reduce as much as possible the level of nickel equivalent, due to the often high price of the metals chosen as nickel substitutes; it should be recalled for example that, in 2012, the price of palladium was around half that of gold, and between a quarter and a half of the price of platinum.

The rectangular domain D2, defined by the following two inequalities:

16≦Créq≦23.5

12≦Niéq≦22

gives a good example of allowable values (by mass) in the case where palladium is used as the main additional metal:
palladium: minimum value 30%, maximum value 40%;
chromium : minimum value 16%, maximum value 20%
molybdenum: minimum value 0%, maximum value 2%
manganese: minimum value 0%, maximum value 2%
copper: minimum value 0%, maximum value 2%
gold: minimum value 0%, maximum value 2%
silicon: minimum value 0%, maximum value 1%
nitrogen: minimum value 0%, maximum value 0.1%
carbon: minimum value 0%, maximum value 0.03%
iron: the complement to 100%.

A more particular alloy consists, in values by mass, of:
palladium: minimum value 30%, maximum value 40%;
copper: minimum value 0%, maximum value 2%;
gold: minimum value 0%, maximum value 2%
total palladium+copper+gold: minimum value 30%, maximum value 40%;
chromium : minimum value 16%, maximum value 20%;
molybdenum: minimum value 0%, maximum value 2%;
manganese: minimum value 0%, maximum value 2%;
silicon: minimum value 0%, maximum value 1%;
nitrogen: minimum value 0%, maximum value 0.1%;
carbon: minimum value 0%, maximum value 0.03%;
iron and inevitable impurities: the complement to 100%.

Generalised to a least one additional metal taken from among the first group or the PGM sub-group, the composition by mass becomes:
total of additional metal or metals from the first group or the PGM sub-group: 30% minimum value, 40% maximum value
chromium: minimum value 16%, maximum value 20%
molybdenum: minimum value 0%, maximum value 2%
manganese: minimum value 0%, maximum value 2%
copper: minimum value 0%, maximum value 2%
gold: minimum value 0%, maximum value 2%
silicon: minimum value 0%, maximum value 1%
nitrogen: minimum value 0%, maximum value 0.1%
carbon: minimum value 0%, maximum value 0.03%
iron: the complement to 100%.

The choice of palladium as the additional metal, more specifically allows the desired properties to be achieved.

A suitable composition (by mass) is 18% chromium, 35% palladium, and 46 to 47% iron. Like any stainless steel, this alloy may contain up to 0.03% of carbon. Preferably, its composition by mass is 18% chromium, 35% palladium, 0% to 0.03% carbon and the complement of iron. More specifically, its composition by mass is 18% chromium, 35% palladium, and from 46.97 to 47% iron, and from 0% to 0.03% carbon.

The invention further concerns a timepiece or jewellery component made of this type of alloy.

1. A stainless steel alloy having a base of iron and chromium, the stainless steel alloy comprising:
chromium: a minimum value of 16%, a maximum value of 20%;
at least one metal selected from the group consisting of copper, ruthenium, rhodium, palladium, rhenium, osmium, iridium, platinum and gold, a total value of the at least one metal ranging from a minimum value of 30% and a maximum value of 40%, such that:
a value of copper ranges from a minimum value of 0% and a maximum value of 2%, and
a value of gold ranges from a minimum value of 0% and a maximum value of 2%;
carbon: a minimum value of 0%, a maximum value of 0.03%;
molybdenum: a minimum value of 0%, a maximum value of 2%;
manganese: a minimum value of 0%, a maximum value of 2%;
silicon: a minimum value of 0%, a maximum value of 1%;
nitrogen: a minimum value of 0%, a maximum value of 0.1%;
tungsten: a minimum value of 0%, a maximum value of 0.5%;
vanadium: a minimum value of 0%, a maximum value of 0.5%;
niobium: a minimum value of 0%, a maximum value of 0.5%;
zirconium: a minimum value of 0%, a maximum value of 0.5%;
titanium: a minimum value of 0%, a maximum value of 0.5%;
iron and inevitable impurities,
in mass % relative to a total mass % of 100%,
wherein the stainless steel alloy comprises less than 0.5% by mass of nickel and is arranged in an austenitic face-centered cubic structure.

2. The alloy of claim 1, wherein the at least one metal is selected from the group consisting of ruthenium, rhodium, palladium, rhenium, osmium, iridium and platinum.

3. The alloy of claim 2, wherein the at least one metal is selected from the group consisting of ruthenium, rhodium, palladium, rhenium, osmium, iridium and platinum.

4. The alloy of claim 1, wherein a sum of the values of the at least one metal,
the manganese and the nitrogen ranges from a minimum value of 30% and a maximum value 40%.

5. The alloy of claim 1, comprising at least one selected from the group consisting of tungsten, vanadium, niobium, zirconium and titanium.

6. The alloy of claim 1, comprising:
palladium: a minimum value of 30%, a maximum value of 40%,
copper: a minimum value of 0%, a maximum value of 2%,
gold: a minimum value of 0%, a maximum value of 2%,
such that a total value of palladium+copper+gold ranges from a minimum value of 30% to a maximum value of 40%;
chromium: a minimum value of 16%, a maximum value of 20%;
molybdenum: a minimum value of 0%, a maximum value of 2%;
manganese: a minimum value of 0%, a maximum value of 2%;
silicon: a minimum value of 0%, a maximum value of 1%;
nitrogen: a minimum value of 0%, a maximum value of 0.1%;
carbon: a minimum value of 0%, a maximum value of 0.03%;
iron and inevitable impurities,
a mass % relative to a total mass % of 100%.

7. The alloy of claim 1, comprising:
chromium: 18%;
palladium: 35%;
carbon: 0% to 0.03%;
iron and inevitable impurities,
in mass % relative to a total mass % of 100%.

8. An article, comprising the alloy of claim 1, said article being a timepiece or a jewelry component.

9. The alloy of claim 2, wherein a sum of the values of the at least one metal, the manganese and the nitrogen ranges from a minimum value of 30% and a maximum value 40%.

10. The alloy of claim 2, comprising at least one selected from the group consisting of tungsten, vanadium, niobium, zirconium and titanium.

11. The alloy of claim 3, comprising at least one selected from the group consisting of tungsten, vanadium, niobium, zirconium and titanium.

12. The alloy of claim 4, comprising at least one selected from the group consisting of tungsten, vanadium, niobium, zirconium and titanium.

13. The alloy of claim 9, comprising at least one selected from the group consisting of tungsten, vanadium, niobium, zirconium and titanium.
